(19) United States
(12) Patent Application Publication
(10) Pub. No.: US 2005/0099442 A1
(43) Pub. Date: May 12, 2005

(54) Printer having a configurable template and methods for configuring a printer template

(75) Inventor: Stephen R. Payne, Cortland, NY (US)

Correspondence Address: Lipsitz & McAllister, LLC, 755 MAIN STREET, MONROE, CT, 06468, US

(73) Assignee: TransAct Technologies Incorporated, Wallingford, CT (US)

(21) Appl. No.: 10/802,351

(22) Filed: Mar. 16, 2004

Related U.S. Application Data
(60) Provisional application No. 60/519,521, filed on Nov. 12, 2003.

(51) Int. Cl. B41J 29/38

(52) U.S. Cl. 347/14

(57) ABSTRACT

The present invention provides methods for configuring a printer template and a ticket printer having a configurable template. Template attributes are received at the printer and stored in printer memory. A processor at the printer creates a template from the template attributes. Print data is provided to the printer memory. The print data is merged into the template to create a composite image. The composite image can then be printed on a substrate. The substrate may comprise a receipt, a lottery ticket, a coupon, a bus ticket, an airplane ticket, a train ticket, a gaming voucher, a slot machine voucher, or the like.

This application claims the benefit of U.S. provisional patent application No. 60/519,521 filed on Nov. 12, 2003, entitled “Smart Printer Including Configurable Ticket Template, Status Updating, Color Conversion, Print Progress Detection, Print Completion Detection, and Paper Low Sensing Features,” which is incorporated herein and made a part hereof by reference.

### BACKGROUND OF THE INVENTION

The present invention relates generally to the field of printing tickets, such as a receipt, a lottery ticket, a bus ticket, an airplane ticket, a train ticket, a gaming voucher, or a slot machine voucher, or the like. More specifically, the present invention provides methods for configuring a printer template and a ticket printer having a configurable template.

The prior art technology for printing tickets employs three basic methods. The first prior art method uses no enhanced interface to the printing device. All commands that are needed to select the print position, font, point size, characters per inch (CPI), and the like are sent to the printer by the host system. The host system is required to have intimate knowledge of the printing device's command interface. This approach has the disadvantage that the host system has to know and send all the commands to the printer to make the printer function.

The second prior art method uses predefined printer macros to complete various “setup commands”. Such commands are used to select the print position, font, point size, CPI, and the like. This method requires that a macro be invoked for each field.

The third prior art method is to provide a template in the printer. A predefined number of print fields is then sent to the printer. Based on the template, the printer invokes pre-defined behavior of how to print the field data that was sent to it. This method has the disadvantage of being rigid.

It would be advantageous to provide configurable printer templates. It would be further advantageous to enable configuration of various template attributes, such as print position, font, point size, CPI, and the like.

The methods and apparatus of the present invention provide the foregoing and other advantages.

### SUMMARY OF THE INVENTION

The present invention relates generally to the field of printing tickets, such as a receipt, a lottery ticket, a bus ticket, an airplane ticket, a train ticket, a gaming voucher, or a slot machine voucher, or the like. More specifically, the present invention provides methods for configuring a printer template and a ticket printer having a configurable template.

In an example embodiment of the present invention, a printer having a configurable template is provided. The printer includes memory for storing received template attributes and received print data. A processor is provided for creating a template from the template attributes and merging the print data into the template to create a composite image. Printing means (e.g., a print driver, a print engine, and the necessary printer mechanicals for producing the image) are provided for printing the composite image on a substrate.

In one example embodiment, the printer may comprise a ticket printer and the substrate may comprise a ticket.

The processor at the printer may create or build a template at the printer in accordance with the received template attributes. Alternatively, the printer may store in the memory one or more configurable templates. The processor may then create the template to be used by the printer by modifying one of the configurable templates in accordance with the template attributes. In such an embodiment, a host system associated with the printer may provide a command to the printer for identifying one of the configurable templates to be modified by the template attributes. This command may comprise an otherwise unused printer command.

The template attributes may be provided by a host system associated with the printer. For example, the template attributes may be input via a user interface associated with the host system. Alternatively, the template attributes may be provided from a removable memory device insertable into the printer. The removable memory device may comprise one of a compact flash card, a smart card, a smart media card, a USB flash drive, a memory stick, a plug in serial EEPROM, or the like.

The template attributes may comprise at least one of number of print fields, print field position, print field area, print position, font style, bold font, italic font, underline text, font size, characters per inch, text orientation, image position, image size, print resolution, barcode type, color, and the like.

The template may contain a number of print fields. The number of print fields may be configurable. Template attributes may be provided for each print field.

The print data may include at least one of text and graphics. The print data may be forwarded from a host system associated with the printer.

The host system may comprise one of a cash register, a point of sale terminal, a slot machine, a gaming terminal, a lottery ticket machine, a transportation ticket vending machine, an entertainment ticket vending machine, or similar type of device. The ticket may comprise one of a receipt, a lottery ticket, a coupon, a bus ticket, an airplane ticket, a train ticket, a gaming voucher, a slot machine voucher, or the like.

The template attributes may include delimiting characters for separating print field data. The delimiting characters may be configurable.

Corresponding methods for configuring a template for a printer are also provided in accordance with the present invention.

### BRIEF DESCRIPTION OF THE DRAWINGS

The present invention will hereinafter be described in conjunction with the appended drawing figures, wherein like reference numerals denote like elements, and:

FIG. 1 shows a block diagram of an example embodiment of the present invention;

FIG. 2 shows a block diagram of a further example embodiment of the present invention;

FIG. 3 shows an example embodiment of a template in accordance with the present invention;

FIG. 4 shows an example embodiment of a printed substrate created using the example template of FIG. 3; and

FIG. 5 (FIGS. 5a and 5b) shows a flowchart illustrating power up and reset of a printer in accordance with an example embodiment of the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

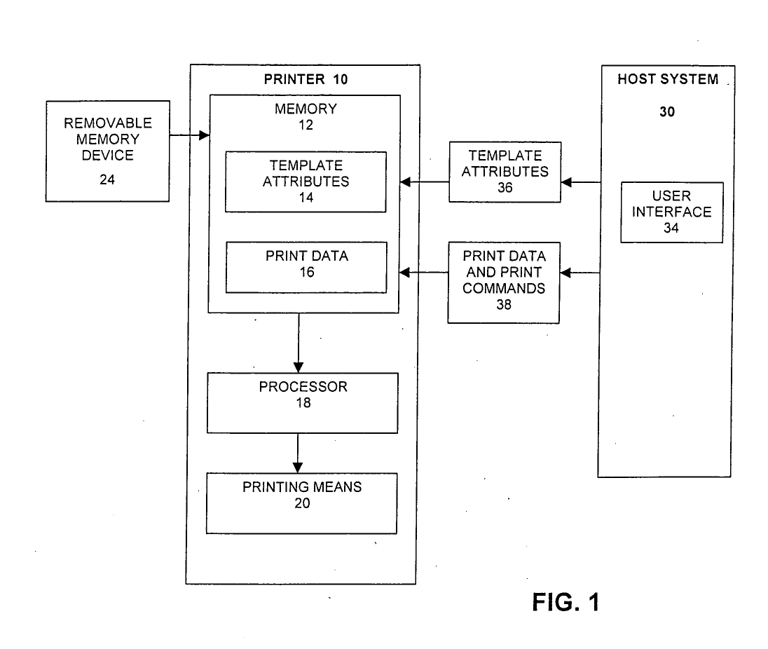

In an example embodiment of the present invention as shown in FIG. 1, a printer 10 having a configurable template is provided. The printer 10 includes memory 12 for storing received template attributes 14 and received print data 16. The memory 12 may comprise non-volatile memory and working memory as is known in the art. A processor 18 is provided for creating a template from the template attributes 14 and merging the print data 16 into the template to create a composite image. Printing means 20 (e.g., a print driver, a print engine, and the necessary printer mechanicals for producing the image) are provided for printing the composite image on a substrate.

In one example embodiment, the printer 10 may comprise a ticket printer and the substrate may comprise a ticket.

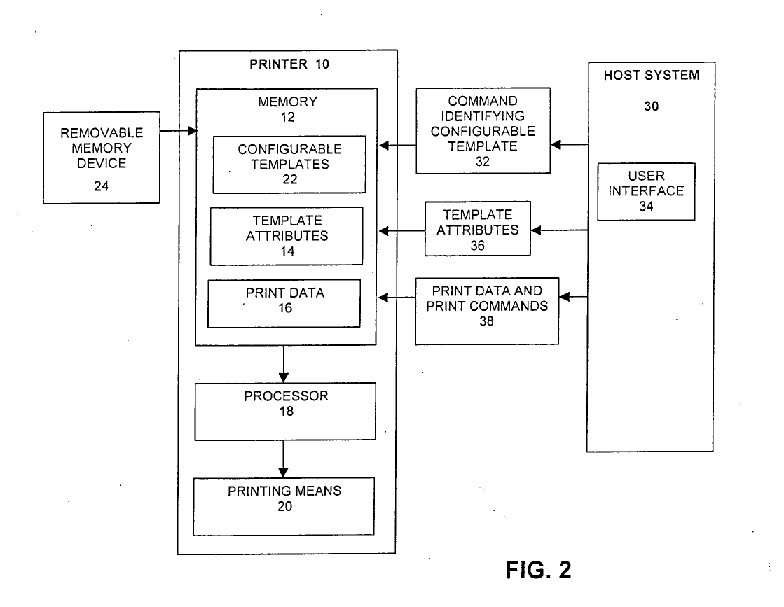

The processor 18 at the printer 10 may create or build the template at the printer 10 in accordance with the received template attributes 14. In an alternative embodiment of the invention as shown in FIG. 2, the printer 10 may store in the memory 12 one or more configurable templates 22. The processor 18 may then create the template to be used by the printer 10 by modifying one of the configurable templates 22 in accordance with the received template attributes 14. In such an embodiment, a host system 30 associated with the printer 10 may provide a command 32 to the printer 10 for identifying one of the configurable templates 22 to be modified by the template attributes 14. This command 22 may comprise an otherwise unused printer command, such as, for example, [ESC]t7, [ESC]3w, [GS]8, or the like.

The template attributes 14 may be provided by the host system 30 associated with the printer 10. For example, the template attributes 14 may be input via a user interface 34 associated with the host system 30 and sent to the printer 10 (as shown at 36). Alternatively, the template attributes 14 may be provided from a removable memory device 24 insertable into the printer 10. The removable memory device 24 may comprise one of a compact flash card, a smart card, a smart media card, a USB flash drive, a memory stick, a plug in serial EEPROM, or the like.

The template attributes 14 may comprise at least one of number of print fields, print field position, print field area, print position, font style, bold font, italic font, underline text, font size, characters per inch, text orientation, image position, image size, print resolution, barcode type, color, and the like.

The print data 16 may include at least one of text and graphics. The print data 16 may be forwarded from a host system 30 associated with the printer 10, together with print commands (as shown at 38).

The host system 30 may comprise one of a cash register, a point of sale terminal, a slot machine, a gaming terminal, a lottery ticket machine, a transportation ticket vending machine, an entertainment ticket vending machine, or similar type of device. The substrate may comprise one of a receipt, a lottery ticket, a coupon, a bus ticket, an airplane ticket, a train ticket, a gaming voucher, a slot machine voucher, or the like.

The template attributes 14 may include delimiting characters for separating print field data. The delimiting characters may be configurable. For example the delimiting characters may be configured to be a comma, a semi-colon, a colon, a period, or the like.

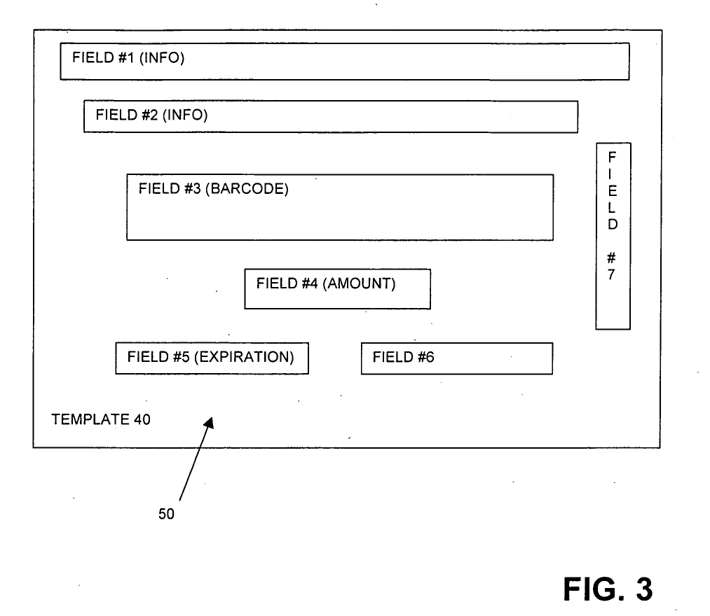

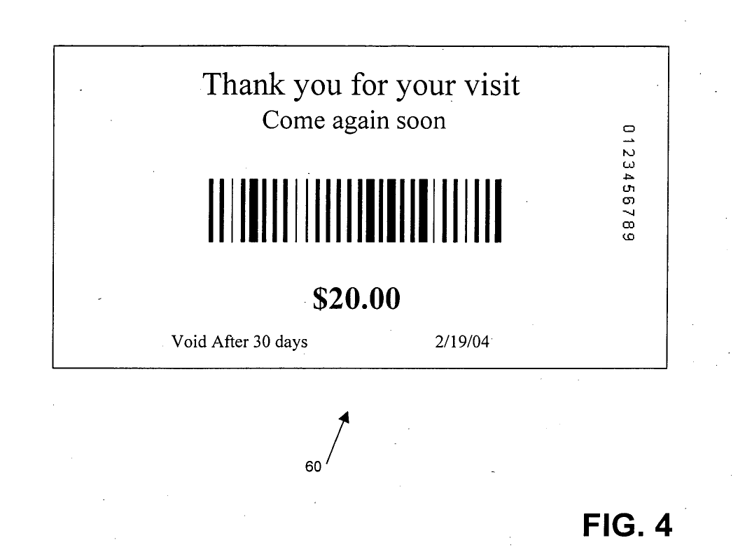

FIG. 3 shows an example template 40 in accordance with the present invention. The template 40 may contain several print fields (e.g., print fields 1-7) in the print area 50. The number of print fields provided in the template 40 may be configurable (e.g., via a command from the host system 30 or via the removable memory device 24). Template attributes may be provided for each print field.

In the example template 40 shown in FIG. 3, the print fields 1-7 are configured to create a voucher or coupon. For example, print fields 1 and 2 may be configured to contain text information, print field 3 may be configured to contain a barcode, print field 4 may be configured to contain the coupon amount, print field 5 may be configured to contain the expiration date of the coupon, print fields 6 and 7 may be left blank or configured to contain other text information or an image. For example, these fields may be configured to contain the name or logo of the establishment at which the coupon is redeemable, serial number, date printed, an image or name of the product for which the coupon can be redeemed, or the like.

Each of the print fields of template 40 may have several configurable attributes, such as print field position, print field area, font used (including font style, bold, italics, underline, font size, text orientation, and the like), image used, barcode type, color, field orientation (field rotation).

FIG. 4 shows an example of a printed substrate 60 created using the example template 40 of FIG. 3. In the example shown in FIG. 4, the substrate comprises a coupon with a value of $20.00 which expires in 30 days from the printed date of Feb. 19, 2004. The coupon 60 also includes a bar code and serial number, along with the text message “Thank you for your Visit, Come Again Soon”.

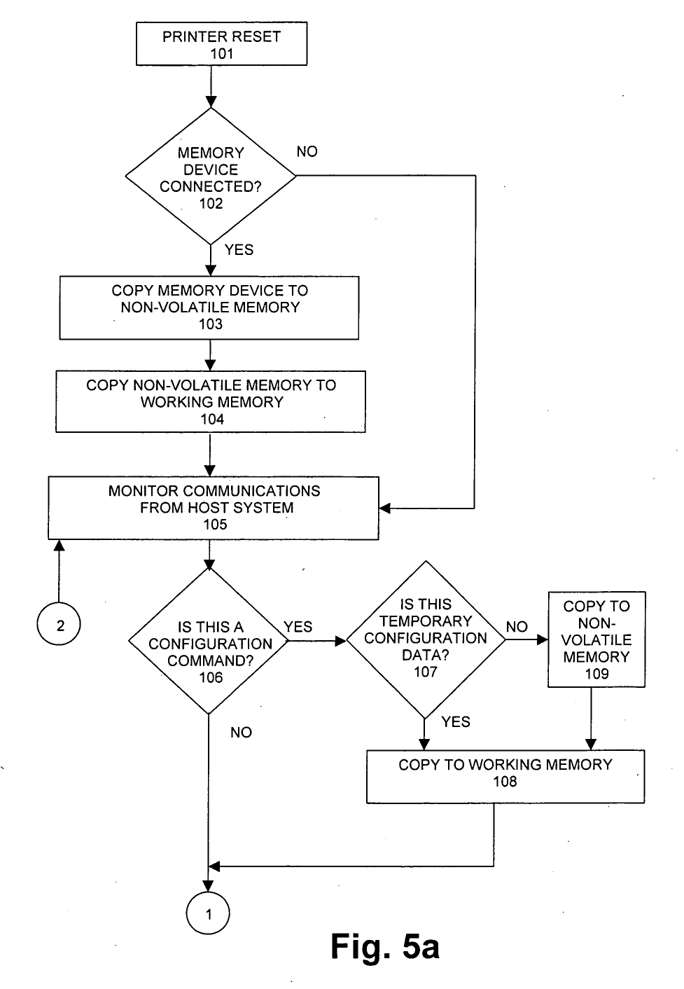

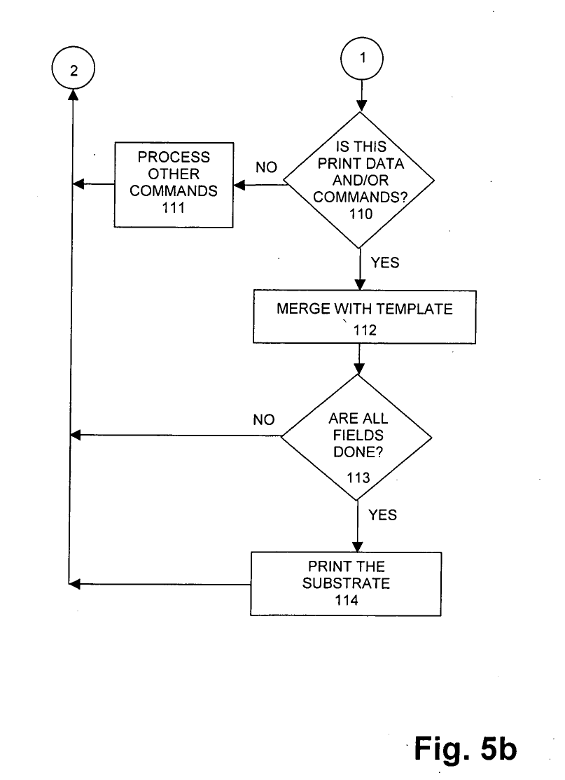

FIG. 5 (FIGS. 5a and 5b) is a flowchart illustrating power up and reset of an example embodiment of a printer in accordance with the present invention. After the printer is reset (101), the printer will determine whether the removable memory device is connected (102). If the removable memory device is connected, the printer will copy the content of the removable memory device (e.g., the template attributes) into non-volatile memory (103). The content of the non-volatile memory may then be copied to working memory of the printer (104). The printer will then monitor for communications from the host system (105). If the removable memory device is not connected, the printer will monitor for communications from the host system (105).

The printer determines whether a communication from the host system is a configuration command (106). If the communication is a configuration command, a determination is made as to whether the command contains temporary configuration data or not (107). If the data is temporary configuration data it is copied to working memory (108). If the data is not temporary configuration data it is first copied to non-volatile memory (109) before being copied to working memory (108). Temporary configuration data is data (e.g., template attributes) that will be lost if the printer is reset or the power is cycled. Non-temporary configuration data is data that is to be retained after a reset or power is cycled. A command may be sent from the printer indicating whether the data is to be treated as temporary or permanent (e.g., whether the template attributes are to be saved or not).

If the communication from the host system is not a configuration command, a determination is made as to whether the command comprises print data and/or print commands (110). If the command does not comprise print data and/or print commands, the commands are processed (111) and the printer continues to monitor communications from the host system (105). If the data is print data and/or print commands, the data is merged with a template created from the configuration data (112). The printer may check to determine whether all template fields are complete (113). If the template fields are not complete, the printer continues to monitor communications from the host system (105) and repeat the above-described process (steps 106 through 113) until the template fields are complete. Once the template fields are complete, the composite image is printed on the substrate (114).

It should now be appreciated that the present invention provides advantageous methods and apparatus for configuring a printer template.

Although the invention has been described in connection with various illustrated embodiments, numerous modifications and adaptations may be made thereto without departing from the spirit and scope of the invention as set forth in the claims.

1. A method for configuring a template for a printer, comprising:
providing template attributes to memory of the printer;
creating a template from the template attributes;
providing print data to the printer memory;
merging the print data into the template to create a composite image; and
printing the composite image on a substrate.

2. A method in accordance with claim 1, wherein:
said printer comprises a ticket printer; and
said substrate comprises a ticket.

3. A method in accordance with claim 1, wherein:
one or more configurable templates are stored at the printer; and
the step of creating the template from the template attributes comprises modifying one of said configurable templates in accordance with said template attributes.

4. A method in accordance with claim 3, further comprising:
providing a command to the printer for identifying one of said configurable templates to be modified by said template attributes.

5. A method in accordance with claim 4, wherein:
said command comprises an otherwise unused printer command.

6. A method in accordance with claim 1, wherein:
the template attributes are provided by a host system associated with the printer.

7. A method in accordance with claim 6, wherein:
the template attributes are input via a user interface associated with the host system.

8. A method in accordance with claim 1, wherein:
the template attributes are provided from a removable memory device insertable into the printer.

9. A method in accordance with claim 8, wherein:
the removable memory device comprises one of a compact flash card, a smart card, a smart media card, a USB flash drive, a memory stick, or a plug in serial EEPROM.

10. A method in accordance with claim 1, wherein:
the template attributes comprise at least one of number of print fields, print field position, print field area, print position, font style, bold font, italic font, underline text, font size, characters per inch, text orientation, image position, image size, print resolution, barcode type, and color.

11. A method in accordance with claim 1, wherein:
said template contains a number of print fields.

12. A method in accordance with claim 11, wherein:
the number of print fields is configurable.

13. A method in accordance with claim 11, further comprising:
providing template attributes for each print field.

14. A method in accordance with claim 1, wherein:
the print data comprises at least one of text and graphics.

15. A method in accordance with claim 1, wherein:
the print data is forwarded from a host system associated with the printer.

16. A method in accordance with claim 1, wherein:
the host system comprises one of a cash register, a point of sale terminal, a slot machine, a gaming terminal, a lottery ticket machine, a transportation ticket vending machine, or an entertainment ticket vending machine.

17. A method in accordance with claim 1, wherein:
the substrate comprises one of a receipt, a lottery ticket, a coupon, a bus ticket, an airplane ticket, a train ticket, a gaming voucher, or a slot machine voucher.

18. A method in accordance with claim 1, wherein:
said template attributes include delimiting characters for separating print field data.

19. A method in accordance with claim 18, wherein:
said delimiting characters are configurable.

20. A printer having a configurable template, comprising:
memory for storing received template attributes and received print data;
a processor for creating a template from the template attributes and merging the print data into the template to create a composite image; and
printing means for printing the composite image on a substrate.

21. A printer in accordance with claim 20, wherein:
said printer comprises a ticket printer; and
said substrate comprises a ticket.

22. A printer in accordance with claim 20, wherein:
said memory stores one or more configurable templates; and
the processor creates the template from the template attributes by modifying one of said configurable templates in accordance with said template attributes.

23. A printer in accordance with claim 22, wherein:
a host system associated with the printer provides a command to the printer for identifying one of said configurable templates to be modified by said template attributes.

24. A printer in accordance with claim 23, wherein:
said command comprises an otherwise unused printer command.

25. A printer in accordance with claim 20, wherein:
the template attributes are provided by a host system associated with the printer.

26. A printer in accordance with claim 25, wherein:
the template attributes are input via a user interface associated with the host system.

27. A printer in accordance with claim 20, wherein:
the template attributes are provided from a removable memory device insertable into the printer.

28. A printer in accordance with claim 27, wherein:
the removable memory device comprises one of a compact flash card, a smart card, a smart media card, a USB flash drive, a memory stick, or a plug in serial EEPROM.

29. A printer in accordance with claim 20, wherein:
the template attributes comprise at least one of number of print fields, print field area, print position, font style, bold font, italic font, underline text, font size, characters per inch, text orientation, image position, image size, print resolution, barcode type, and color.

30. A printer in accordance with claim 20, wherein:
said template contains a number of print fields.

31. A printer in accordance with claim 30, wherein:
the number of print fields is configurable.

32. A printer in accordance with claim 30, wherein:
template attributes are provided for each print field.

33. A printer in accordance with claim 20, wherein:
the print data comprises at least one of text and graphics.

34. A printer in accordance with claim 20, wherein:
the print data is forwarded from a host system associated with the printer.

35. A printer in accordance with claim 20, wherein:
the host system comprises one of a cash register, a point of sale terminal, a slot machine, a gaming terminal, a lottery ticket machine, a transportation ticket vending machine, or an entertainment ticket vending machine.

36. A printer in accordance with claim 20, wherein:
the substrate comprises one of a receipt, a lottery ticket, a coupon, a bus ticket, an airplane ticket, a train ticket, a gaming voucher, or a slot machine voucher.

37. A printer in accordance with claim 20, wherein:
said template attributes include delimiting characters for separating print field data.

38. A printer in accordance with claim 37, wherein:
said delimiting characters are configurable.
